(19) United States
(12) Patent Application Publication
(10) Pub. No.: US 2003/0040239 A1
(43) Pub. Date: Feb. 27, 2003

(54) Thermal insulation containing supplemental infrared radiation absorbing material

(75) Inventors: Murray S. Toas, Norristown, PA (US); Kurt Mankell, Blue Bell, PA (US); Kevin Gallagher, Plymouth Meeting, PA (US); Dave Ober, Doylestown, PA (US); Gary Tripp, Corbin, KY (US); Alain Yang, Bryn Mawr, PA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: CERTAINTEED CORPORATION, Valley Forge, PA

(21) Appl. No.: 09/858,471

(22) Filed: May 17, 2001

(51) Int. Cl. B32B 27/04; B32B 27/12

(52) U.S. Cl. 442/131; 442/132; 442/133; 442/180

(57) ABSTRACT

A thermal insulation product includes infrared radiation absorbing material dispersed on fibers forming a porous structure. The infrared absorbing material can include borates, carbonates, nitrates and nitrites of alkali metals and alkaline earth metals.

### BACKGROUND OF THE INVENTION

1. Field of the Invention

This invention relates to thermal insulation. More specifically, this invention relates to thermal insulation containing infrared radiation (“IR”) absorbing and scattering material, which reduces radiative heat transfer through the thermal insulation.

2. Description of Related Art

Heat passes between two surfaces having different temperatures by three mechanisms: convection, conduction and radiation. These heat transfer mechanisms are combined in a quantitative measure of heat transfer known as “apparent thermal conductivity.”

Insertion of glass fiber thermal insulation in the gap between two surfaces reduces convection as a heat transport mechanism because the insulation slows or stops the circulation of air. Heat transfer by conduction through the glass fiber of the insulation is also minimal. However, many glass compositions used in glass fiber insulation products are transparent in portions of the infrared spectrum. Thus, even when the gap between surfaces has been filled with glass fiber thermal insulation, radiation remains as a significant heat transfer mechanism. Typically, radiation can account for 10 to 40% of the heat transferred between surfaces at room (e.g., 24° C.) temperature.

Fiber to fiber radiative heat transfer is due to absorption, emission and scattering. The amount of radiative heat transfer between fibers due to emission and absorption is dependent on the difference in fiber temperatures, with each fiber temperature taken to the fourth power.

To reduce radiative heat loss through thermal insulation, a number of approaches have been considered.

U.S. Pat. No. 2,134,340 discloses that multiple reflections of infrared radiation from a powder of an infrared transparent salt, such as calcium fluoride, added to glass fiber insulation can prevent the infrared radiation from penetrating any substantial distance into the insulation.

U.S. Pat. No. 5,633,077 discloses that an insulating material combining certain chiral polymers with fibers can block the passage of infrared radiation through the insulating material.

U.S. Pat. No. 5,932,449 discloses that glass fiber compositions displaying decreased far infrared radiation transmission may be produced from soda-lime borosilicate glasses having a high boron oxide content and a low concentration of alkaline earth metal oxides.

There remains a need for a cost effective thermal insulation product that can reduce radiative heat loss.

### SUMMARY OF THE INVENTION

A thermal insulation product is provided in which an IR absorbing and scattering material is dispersed on fibers arranged in a porous structure. The IR absorbing and scattering material can be applied to the fibers before or after the fibers are formed into the porous structure. The IR absorbing and scattering material substantially reduces the radiative heat loss through the thermal insulation. Inclusion of the IR absorbing and scattering material improves the effective wavelength range over which the porous structure absorbs infrared radiation and improves its overall extinction efficiency. The IR absorbing and scattering materials are about as effective as glass fiber in reducing radiative heat loss through a porous fiber structure, but they can be much less expensive than glass fiber. Hence, the IR absorbing and scattering material can provide a cost-effective means of improving thermal insulation.

### BRIEF DESCRIPTION OF THE DRAWINGS

The preferred embodiments of the invention will be described in detail, with reference to the following figures, wherein:

FIG. 1 shows the absorption spectra of silica, glass fiber, calcium carbonate and borax;

FIG. 2 shows a method of applying IR absorbing and scattering material to fibers;

FIG. 3 shows a method of adding IR absorbing and scattering material to an unbonded glass fiber mat;

FIG. 4 shows a method of applying IR absorbing and scattering material to fibers including recycled fiberglass; and

FIG. 5 shows a method of applying IR absorbing and scattering material to fibers.

### DETAILED DESCRIPTION OF PREFERRED EMBODIMENTS

The present invention reduces the radiant transmission of heat through a fiber based thermal insulation product by dispersing an IR absorbing and scattering material onto the fibers. Because the IR absorbing and scattering material can be less expensive than the fiber, the substitution of the IR absorbing and scattering material for some of the fiber can lead to a significant cost reduction in thermal insulation.

A suitable IR absorbing and scattering material absorbs and scatters infrared radiation with a wavelength in the 4 to 40 μm range. Preferably, the IR absorbing and scattering material absorbs 6-8 μm (1667-1250 cm⁻¹) infrared radiation. The IR absorbing and scattering material can include one or more alkali metal salts or alkaline earth metal salts containing borates, carbonates, nitrates and nitrites. Borates and carbonates are preferred. Suitable borates include lithium borate, sodium borate, potassium borate, magnesium borate, calcium borate, strontium borate and barium borate. Preferably, the borate is sodium borate (i.e., borax). Suitable carbonates include lithium carbonate, sodium carbonate, potassium carbonate, magnesium carbonate, calcium carbonate, strontium carbonate and barium carbonate. Preferably, the carbonate is calcium carbonate.

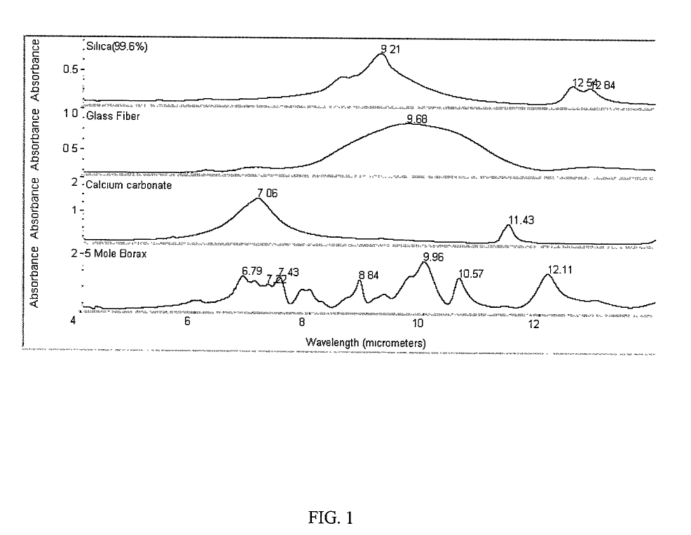

FIG. 1 shows the absorption spectra of borax and calcium carbonate. The absorption characteristics of borax and calcium carbonate complement those of glass fiber and silica, which have been used commercially in thermal insulation for over fifty years.

The amount of IR absorbing and scattering material in the thermal insulation product can range from 1 to 40 wt %, preferably from 2 to 30 wt %, more preferably from 4 to 20 wt %. If the amount of IR absorbing and scattering material is less than 1 wt %, then the reduction in radiative heat loss is negligible. If the amount of IR absorbing material is in excess of 40 wt %, then the IR absorbing and scattering material forms an undesirable amount of dust in the thermal insulation product.

The fibers in the thermal insulation product can be organic or inorganic. Organic fibers include cellulose fibers; cellulosic polymer fibers, such as rayon; thermoplastic polymer fibers, such as polyester; animal fibers, such as wool; and vegetable fibers, such as cotton. Preferably, the fibers are inorganic. Inorganic fibers include rock wool and glass wool. Preferably, the inorganic fibers comprise a glass.

The fibers form a porous structure. The porous structure can be woven or nonwoven. Preferably, the porous structure is nonwoven. The nonwoven fibers can be in the form of a batt, mat or blanket. A preferred porous structure is that found in FIBERGLASS.

Along with the fibers and IR absorbing and scattering material, the thermal insulation product can include a binder to capture and hold the fibers and IR absorbing material together. The binder can be a thermosetting polymer, a thermoplastic polymer, or an inorganic bonding agent. Preferably, the thermosetting polymer is a phenolic resin, such as a phenol-formaldehyde resin. The thermoplastic polymer will soften or flow upon heating to capture the fibers and IR absorbing and scattering material, and upon cooling and hardening will hold the fibers and IR absorbing and scattering material together. In embodiments of the present invention, the IR absorbing and scattering material can itself bond fibers together and thus render the addition of a binder unnecessary. When binder is used in the thermal insulation product, the amount of binder can be from 1 to 35 wt %, preferably from 3 to 30 wt %, more preferably from 4 to 25 wt %.

The thermal insulation product of the present invention can be formed by dispersing the IR absorbing and scattering material on to the surface of fibers, and by forming the fibers into a porous structure. The infrared absorbing and scattering material can be dispersed on the fibers before or at the same time or after the fibers are formed into the porous structure. Methods of forming fibers into porous structures are well known to the skilled artisan and will not be repeated here in detail.

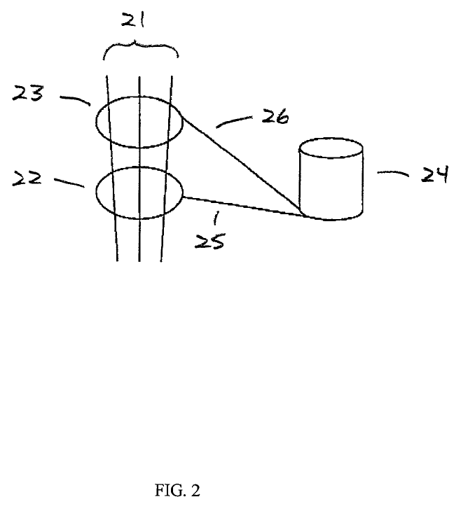

FIG. 2 shows a method of depositing IR absorbing and scattering material on glass fibers. Glass fibers 21 pass through a water overspray ring 23 and a binder application ring 22. Tank 24 is connected via lines 25 and 26 to rings 22 and 23, respectively. In tank 24 an IR absorbing and scattering material is dissolved or suspended in a liquid mixture. The IR absorbing and scattering material is applied to the glass fibers 21 by injecting the liquid mixture from tank 24 into the binder application ring 22 and/or the water overspray ring 23. The liquid mixture can include water and various surfactants and suspension agents. If the IR absorbing and scattering material is not completely dissolved in the liquid mixture, the liquid mixture must be agitated to keep the IR absorbing and scattering material in suspension. The spray nozzles in rings 22 and 23 have nozzle orifices large enough to permit undissolved IR absorbing and scattering materials to pass through the nozzles without clogging.

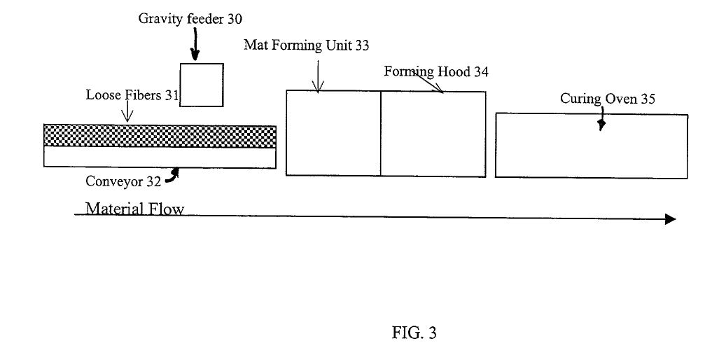

FIG. 3 shows an embodiment in which binder and IR absorbing and scattering material are dispersed from gravity feeder 30 on top of loose fibers 31 that have been distributed across the width of a conveyor 32 to form a porous mat. The IR absorbing and scattering material is introduced into the porous mat separately from or premixed with a binder. The binder can be a dry powder. The fibers with binder and IR absorbing and scattering material dispersed on the fibers then pass through a mat forming unit 33 where they are mixed and delivered into the air lay forming hood 34. The binder and IR absorbing and scattering material may also be added at the mat forming unit 33. The mix is then collected through negative pressure on another conveyor (not shown) and transported into a curing oven 15. When passed through curing oven 35, the binder melts, cures, and binds together the IR absorbing material and fiber.

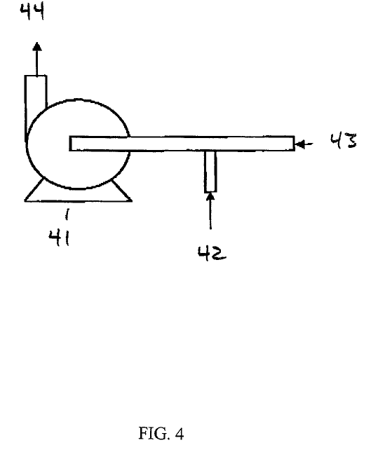

FIG. 4 shows an embodiment in which a recycling fan 41 is used to suck in and mix IR absorbing material (e.g., calcium carbonate powder) from fan intake 42 and recycled glass fiber from fan intake 43. The IR absorbing and scattering material and recycled glass fibers are blown from fan 41 at exit 44 into a forming hood (not shown). There the mixture is dispersed on glass fiber, together with a binder, if necessary. After passing through a curing oven (not shown) the IR absorbing and scattering material materials and glass fibers are bonded together.

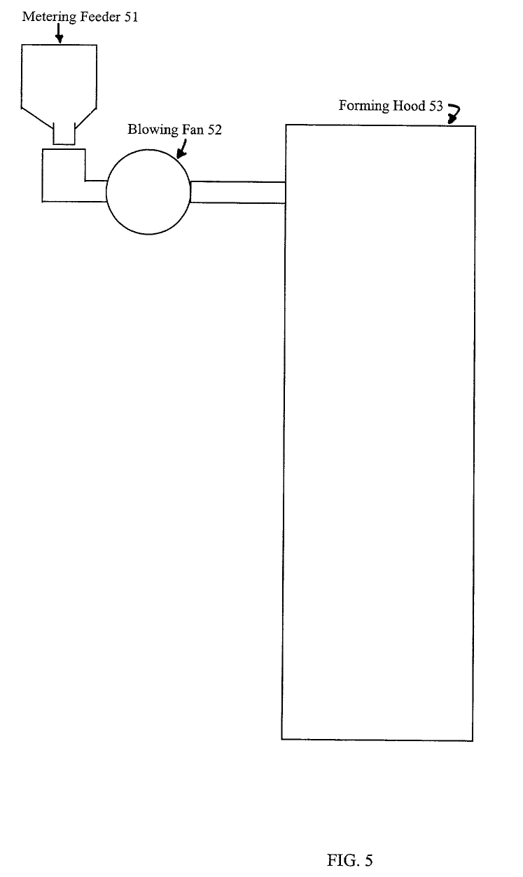

FIG. 5 shows an embodiment in which a metering feeder 51 feeds the dry, powder IR absorbing and scattering material into a blowing fan 52. The IR absorbing and scattering material is blown by the fan into the forming hood 53 and dispersed on glass fiber with a binder, if necessary. Multiple feeders and blowing fans may be used.

### EXAMPLES

The following non-limiting examples will further illustrate the invention.

### Example 1

FIBERGLASS samples are prepared in a laboratory with either borax {Na₂B₄O₇•5H₂O} or calcium carbonate dispersed throughout as IR absorbing and scattering materials. The samples are 12″ wide×12″ long×1″ thick. The IR absorbing materials are weighed and mixed in a solution of 30% isopropanol and 70% water. The borax is dissolved in the water using a mixer and a hot plate to form a borax solution. The calcium carbonate is mixed in the alcohol/water by hand to form a calcium carbonate suspension. The liquid mixtures containing the IR absorbing and scattering material are loaded onto the samples either by soaking or by spraying. The soaking is performed by pouring 240 ml of one of the liquid mixtures onto each sample and soaking the sample. The spraying is performed by using a spray bottle to spray 120 ml of one of the liquid mixtures onto each sample. The apparent thermal conductivity of each of the samples is measured before and after the IR absorbing material is added. The apparent thermal conductivities are shown in Table 1.

TABLE 1

| | | | | | | Reduction in |
|---|---|---|---|---|---|---|
| | | | | | | apparent |
| | | | | IRM* | Apparent | thermal |
| | | | | added to | thermal | conductivity |
| | | | | fiberglass | conductivity** | through the |
| | | | | vs virgin | before addition | addition of |
| | Fiberglass | IRM* or | | sample | of IRM* or | IRM* or |
| | density | ground glass | Application | weight | ground glass | ground glass |
| Sample | (lb/ft³) | powder | Method | (wt %) | powder | powder |
| 1 | 0.544 | CaCO₃ | Soaking | 5.5% | 0.2983 | 1.9% |
| 2 | 0.654 | CaCO₃ | Soaking | 13.3% | 0.2861 | 2.2% |
| 3 | 0.438 | CaCO₃ | Soaking | 14.9% | 0.3309 | 3.0% |
| 4 | 0.523 | CaCO₃ | Soaking | 23.0% | 0.3067 | 4.9% |
| 5 | 0.569 | CaCO₃ | Soaking | 48% | 0.2979 | 5.8% |
| 6 | 0.661 | Ground | Soaking | 24% | 0.2825 | 2.5% |
| | | glass, same | | | | |
| | | composition | | | | |
| | | as the glass | | | | |
| | | fiber | | | | |
| 7 | 0.422 | Borax | Spraying | 3.1% | 0.3408 | 0.6% |
| 8 | 0.454 | Borax | Soaking | 8.6% | 0.3304 | 1.7% |

*IRM = infrared absorbing material
**Thermal conductivity units = (BTU inch/hr ft² F.) tested by ASTM C518 test method at 75° F. mean temperature

Table 1 shows that the addition of borax or calcium carbonate to FIBERGLASS results in a reduction in the apparent thermal conductivity of the insulation. For the samples with calcium carbonate, the percentage reduction in thermal conductivity is roughly proportional to the percentage of calcium carbonate applied to the FIBERGLASS.

Comparative samples showing the reduction in apparent thermal conductivity produced by adding glass fiber to insulation are provided by standard R11, R13 and R15 FIBERGLASS insulation, as shown in Table 2.

TABLE 2

| | | | Apparent | Reduction in |
|---|---|---|---|---|
| | | | thermal | thermal |
| | | Added glass | conductivity** | conductivity |
| | | fiber | before the | through |
| | | relative to | addition of | addition |
| R-Value at 3.5” | Density | R11 | glass | of glass fiber |
| Thick | (pcf) | (wt %) | fiber | (%) |
| R11 | 0.536 | — | 0.3182 | — |
| R13 | 0.801 | 49.3 | 0.2692 | 15.4 |
| R15 | 1.40 | 160.6 | 0.2333 | 26.7 |

**Thermal conductivity units = (BTU inch/hr ft² F.) tested by ASTM C518 test method at 75° F. mean temperature

### Example 2

Two sets of FIBERGLASS samples of varying compositions in a fiberglass insulation manufacturing process are prepared. The first set of samples is maintained as a reference. To the second set of samples is added 12 wt % calcium carbonate. The apparent thermal conductivity at 75° F. mean temperature of each sample as a function of density is determined by ASTM test procedure C518 and shown in Table 4.

TABLE 3

| | | Apparent |
|---|---|---|
| | Apparent | thermal |
| | thermal | conductivity** |
| Fiberglass | conductivity** | standard |
| Density | standard | product with |
| (lb/ft³) | product | 12 wt % CaCO₃ |
| 0.500 | 0.3288 | 0.3335 |
| 0.560 | 0.3132 | 0.3173 |
| 0.700 | 0.2872 | 0.2906 |
| 0.784 | 0.2762 | 0.2792 |
| 0.800 | 0.2744 | 0.2773 |
| 0.896 | 0.2648 | 0.2674 |

**Thermal conductivity units = (BTU inch/hr ft² F.) tested by ASTM C518 test method at 75° F. mean temperature

Using the data in Table 3, the reduction in apparent thermal conductivity resulting from the addition of calcium carbonate is compared with the reduction in apparent thermal conductivity resulting from an increase in glass density in the FIBERGLASS insulation. The results are shown in Table 4.

TABLE 4

| | | Reduction in | Reduction in |
|---|---|---|---|
| | | apparent | apparent |
| | | thermal | thermal |
| | Reduction in | conductivity** | conduc- |
| | apparent thermal | from | tivity** by |
| Range over which | conductivity** from | 12 wt % | CaCO₃ |
| glass density | 12% increase in | addition of | compared to |
| increased 12% | glass fiber density | CaCO₃ | glass fiber |
| From 0.500 to 0.560 | 4.7% | 3.5% | 74% |
| From 0.700 to 0.784 | 3.8% | 2.8% | 74% |
| From 0.800 to 0.896 | 3.5% | 2.5% | 71% |

**Thermal conductivity = (BTU inch/hr ft² F.) tested by ASTM C518 test method at 75° F. mean temperature

Table 4 shows that the addition of 12 wt % calcium carbonate to FIBERGLASS is approximately 73% as effective as a 12% increase in FIBERGLASS density in reducing the apparent thermal conductivity of FIBERGLASS thermal insulation. Thus, about 1.37 (=1/0.73) times as much calcium carbonate as glass fiber must be added to achieve the same reduction in apparent thermal conductivity.

However, the cost of calcium carbonate can be less than 50% of the cost of glass fiber. Thus, the cost for reducing the thermal conductivity of FIBERGLASS insulation with calcium carbonate can be 68% (=(100)(1.37)(0.50)) or less than that of the cost of the same thermal conductivity reduction with glass fiber. Thus, calcium carbonate is a more cost-effective additive to FIBERGLASS than glass fiber for reducing the apparent thermal conductivity of the thermal insulation.

### Example 3

A fiberglass insulation sample with 12 wt % calcium carbonate is prepared in a fiberglass manufacturing process. Table 5 shows the reduction in apparent thermal conductivity at various temperatures compared to a fiberglass insulation sample with no calcium carbonate.

TABLE 5

| Apparent | | Reduction in apparent |
|---|---|---|
| thermal | | thermal conductivity** |
| conductivity** | | by CaCO₃ compared to |
| test temperature | Reduction in apparent thermal | a 12 wt % weight |
| (product density = | conductivity** from 12 wt % | increase with glass |
| 1.5 lb/ft³) | addition of CaCO₃ | fiber |
| 10° C. | 0.6% | 24% |
| 50° C. | 4.6% | 132% |
| 400° C. | 19.2% | 233% |

**Thermal conductivity units = (BTU inch/hr ft² F.) tested by ASTM C518 test method.

While the present invention has been described with respect to specific embodiments, it is not confined to the specific details set forth, but includes various changes and modifications that may suggest themselves to those skilled in the art, all falling within the scope of the invention as defined by the following claims.

What is claimed is:

1. A thermal insulation product comprising fibers; and
at least one carbonate dispersed on the fibers, wherein the product further comprises a porous structure.

2. The product according to claim 1, wherein at least a portion of the at least one carbonate is dispersed on fibers inside the thermal insulation product.

3. The product according to claim 1, wherein the porous structure is nonwoven.

4. The product according to claim 1, wherein the fibers are inorganic.

5. The product according to claim 1, wherein the fibers comprise a glass.

6. The product according to claim 1, wherein the product comprises the at least one carbonate in an amount of from 1 to 40% by weight.

7. The product according to claim 1, wherein the at least one carbonate comprises calcium carbonate.

8. The product according to claim 1, further comprising a binder selected from the group consisting of thermosetting polymers, thermoplastic polymers, and inorganic compounds.

9. The product according to claim 1, wherein the at least one carbonate absorbs infrared radiation having a wavelength in a range of 4 to 40 μm.

10. The product according to claim 1, wherein the at least one carbonate absorbs infrared radiation having a wavelength in a range of 6 to 8 μm.

11. A method of forming a thermal insulation product, the method comprising dispersing a carbonate on fibers; and
forming the fibers into a porous structure.

12. The method according to claim 11, wherein the carbonate comprises calcium carbonate.

13. The method according to claim 11, wherein the dispersing comprises soaking or spraying the fibers with a liquid mixture containing the carbonate.

14. The method according to claim 13 herein the carbonate is suspended in the liquid mixture.

15. The method according to claim 11 wherein the carbonate is dispersed on the fibers after the fibers are formed into the porous structure.

16. The method according to claim 11, wherein the dispersing comprises mixing the carbonate and the fibers.

17. The method according to claim 11, wherein the dispersing comprises
mixing the carbonate and the fibers;
heating the carbonate; and
binding the fibers together with the carbonate.

18. The method according to claim 17, wherein the mixing comprises sucking or blowing a dry powder of the carbonate into the porous structure.

19. The method according to claim 11, wherein the dispersing comprises mixing the carbonate, the fibers and a binder.

20. The method according to claim 11, wherein the dispersing comprises
mixing the carbonate and the fibers with a binder;
heating the binder; and
binding the fibers and the carbonate together with the binder.

21. The method according to claim 20, wherein the mixing comprises sucking or blowing the binder and a dry powder of the carbonate into the porous structure.

22. The method according to claim 11, wherein the porous structure is nonwoven.

23. The method according to claim 11, wherein the fibers are inorganic.

24. The method according to claim 11, wherein the fibers comprise a glass.
